(19) United States
(12) Patent Application Publication
(10) Pub. No.: US 2021/0241372 A1
(43) Pub. Date: Aug. 5, 2021

(54) SYSTEM, APPARATUS, AND METHOD FOR DATA TRADING BASED ON BLOCKCHAIN

(71) Applicant: MOAC Blockchain Technology Inc., Palo Alto, CA (US)

(72) Inventors: Yang Chen, Bellevue, CA (US); Xinle Yang, Portland, OR (US); Debin Liu, Bellevue, WA (US); Qing Xu, Shanghai (CN)

(73) Assignee: MOAC Blockchain Technology Inc., Palo Alto, CA (US)

(21) Appl. No.: 16/781,481

(22) Filed: Feb. 4, 2020

(51) Int. Cl. G06Q 40/04; G06F 16/23; G06Q 20/36; G06Q 20/38; G06Q 20/12

(52) U.S. Cl. CPC G06Q 40/04; G06F 16/2379; G06Q 20/3674; G06Q 2220/00; G06F 16/2365; G06Q 20/123; G06Q 20/3825

(57) ABSTRACT

A method of trading data includes posting, in a data trading system, data information related to data that is located in a storage apparatus independent of the data trading system and available for purchase and receiving, from a purchaser device, a compensation for the data. The method also includes facilitating, at least partially through a smart contract on a blockchain, a transfer of the data directly from the storage apparatus to the purchaser device; and facilitating, at least partially through the smart contract on a blockchain, a transfer of the compensation from the data trading system to a provider account.

### TECHNICAL FIELD

The present disclosure relates generally to the trading of information over computer networks, and more particularly, to systems, apparatuses, and methods for trading data based on blockchain.

### BACKGROUND

With reference to FIG. 1, existing data trading transactions are generally conducted directly between a data purchaser and the data provider. To this end, a data provider posts or advertises data that is available for purchase, a data purchaser locates and elects to purchase the data, and a financial transaction of such purchase is executed between the parties. After the financial transaction is successfully executed, the data provider provides a token and a data interface, e.g., a uniform resource locator (URL) that references the location of the data, to the data purchaser. The data purchaser uses this token and URL to obtain the corresponding purchased data information through the data interface at a specified time.

The foregoing data trading method is executed directly between the data purchaser and the data provider, and thus relies on the data purchaser becoming aware of the data available from the data provider and initiating a transaction. It may be beneficial to involve a third-party trading system that matches data providers with data purchasers, thus removing the burden of having to locate data of interest from the data purchaser. It, however, may be difficult to introduce third-party data partners into the data trading process in that the additional third party may lead to mistrust among the various parties, under various scenarios:

With reference to FIG. 2A, in a first scenario involving a third-party trading system, a data provider transfers data directly to the third-party system, which in turn facilitates the purchase and transfer of data on behalf of the data provider and a data purchaser. This scenario may result in distrust by the data provider because the trading system may store a backup of the provider's data on its own server. Thus, enabling the trading system to sell the data directly in the market without knowledge or involvement by the data provider. As a result, the data provider's interests are impaired.

With reference to FIG. 2B, in a second scenario involving a third-party trading system, the provider lists data on the trading system but the data is not transferred to the trading system. Instead, the trading system provides a token and a data interface, e.g., a uniform resource locator (URL) that references the location of the data, to the data purchaser. This scenario may lead to distrust by the trading system because the data purchaser and the data provider may choose to deal directly with each other in future transactions without going through the trading system. For example, after conducting an initial data exchange through the trading system, the data purchaser may pay a token directly to the data provider on future data exchange transactions and thereby bypass the trading system. As a result, the trading system may experience loss revenue.

It is therefore desirable to provide a user the ability to centralize the storage of her user information and the ability to control access to user information. The concepts disclosed below address this need and others.

### SUMMARY

A method of trading data includes posting, in a data trading system, data information related to data that is located in a storage apparatus independent of the data trading system and available for purchase; and receiving, from a purchaser device, a compensation for the data. The method also includes facilitating, at least partially through a smart contract on a blockchain, a transfer of the data directly from the storage apparatus to the purchaser device; and facilitating, at least partially through the smart contract on a blockchain, a transfer of the compensation from the data trading system to a provider account.

The data information may be posted by appending the data information to the smart contract on the blockchain. Data products of interest may be found by searching the data information posted in the smart contract on the blockchain against a search query received from the purchaser device. At least a portion of the data information from the blockchain is made available to a system server when the search query results in a match by transmitting the portion of the data information from the blockchain to the system server. The data information is output by the system server for display on a user interface at the purchaser device.

The transfer of data is facilitated by generating through the smart contract on a blockchain, a data-product token comprising at least a portion of the data information corresponding to the data; appending the data-product token to the smart contract together with a signature of the data trading system; and transmitting the data-product token to the purchaser device. Data transfer is further facilitated by receiving, from a provider device, a verified token indicating that the transfer of the data associated with the data-product token has been completed. The transfer of the compensation is facilitated by transferring through the smart contract on a blockchain, to the account associated with the data, an amount corresponding to the compensation for the data.

An apparatus for trading data, includes a network interface, a memory, and a processor coupled to the network interface and the memory. The processor is configured to post, in a data trading system, data information related to data that is located in a storage apparatus independent of the data trading system and available for purchase. The processor is also configured to receive, from a purchaser device, a compensation for the data. The processor is further configured to facilitate, at least partially through a smart contract on a blockchain, a transfer of the data directly from the storage apparatus to the purchaser device; and to facilitate, at least partially through the smart contract on a blockchain, a transfer of the compensation from the data trading system to a provider account.

A mechanism for trading data includes a collection/posting module configured to post, in a data trading system, data information related to data that is located in a storage apparatus independent of the data trading system and available for purchase; and a search/purchase module configured to receive, from a purchaser device, a compensation for the data. The mechanism for trading data also includes a data transfer module configured to facilitate, at least partially through a smart contract on a blockchain, a transfer of the data directly from the storage apparatus to the purchaser device; and a payment module configured to facilitate, at least partially through the smart contract on a blockchain, a transfer of the compensation from the data trading system to a provider account.

It is understood that other aspects of methods, apparatuses and mechanisms, will become readily apparent to those skilled in the art from the following detailed description, wherein various aspects are shown and described by way of illustration.

### BRIEF DESCRIPTION OF THE DRAWINGS

Various aspects of systems, apparatuses, and methods will now be presented in the detailed description by way of example, and not by way of limitation, with reference to the accompanying drawings, wherein:

FIG. 1 is an illustration of a conventional model of a data exchange directly between a data provider and a data purchaser.

FIGS. 2A and 2B are illustrations of data exchanges involving a third-party trading system that invoke different scenarios of distrust.

FIG. 3 is an illustration of a data trading system that includes a server and a group of nodes of a decentralized network forming an application shard that implements a data trading mechanism with blockchain functionality.

FIG. 4 is an illustration of components of the data trading system of FIG. 3.

FIG. 5 is a process flow diagram of data trading transaction executed by the trading system of FIG. 3.

FIG. 6 is a flowchart of a method of trading data.

FIG. 7 is a block diagram of an apparatus configured to implement the process of FIG. 5 and the method of FIG. 6.

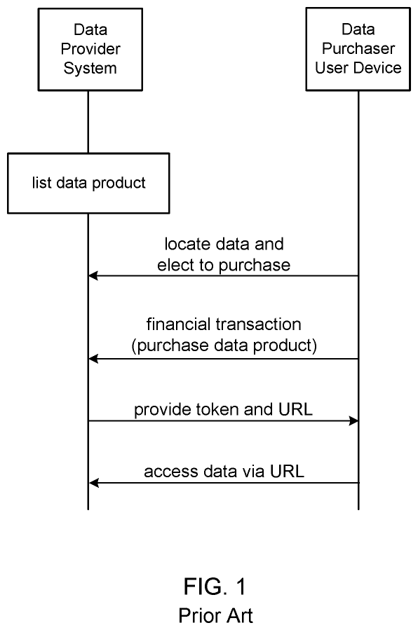

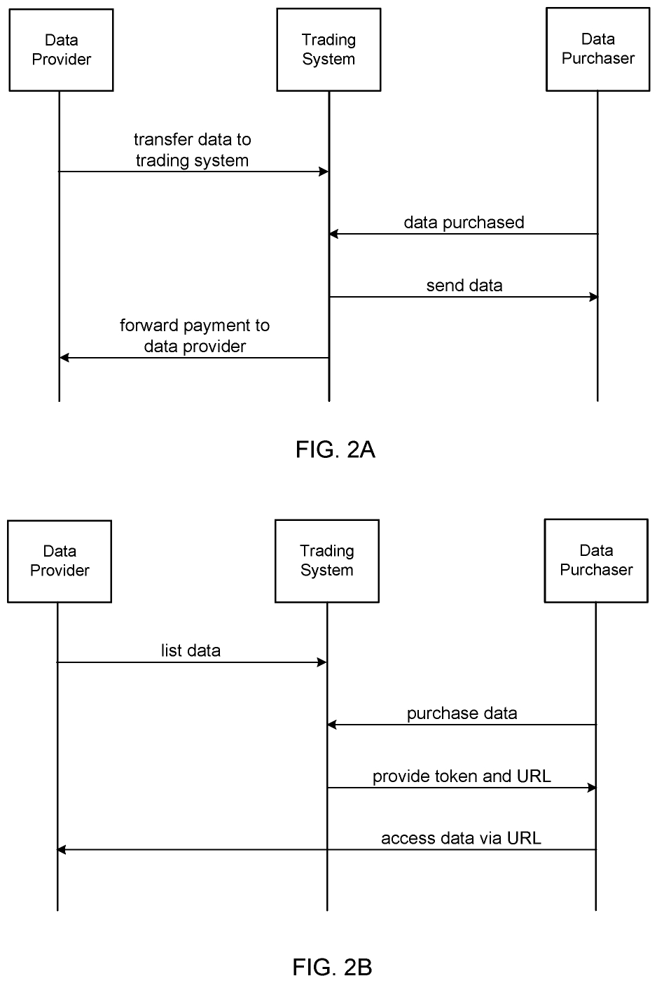

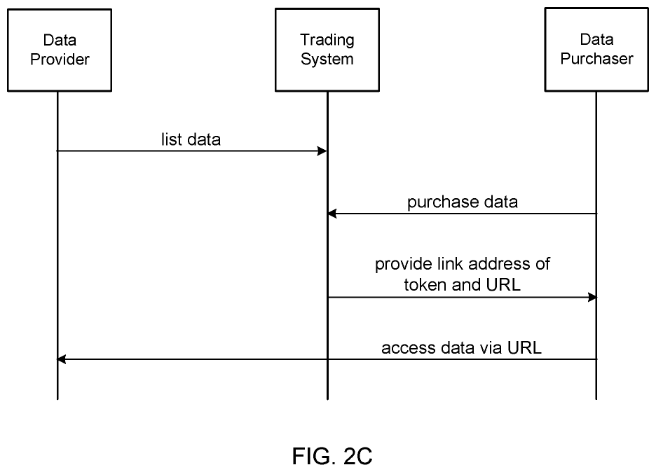

### DETAILED DESCRIPTION

Disclosed in detail below are a system, apparatus, and method for trading data based on blockchain. The apparatus, which may be a node in a decentralized network of nodes, is configured to implement various functions of a data trading mechanism including the posting of information related to data that is available for purchase, and the execution of blockchain functions to facilitate the purchase of data and the transferring of data. The data trading mechanism employs a smart contract on a blockchain and an asymmetric cryptographic authentication mechanism on the blockchain to ensure that third-party data trading systems participate in the matching data trading transaction in a trusted manner.

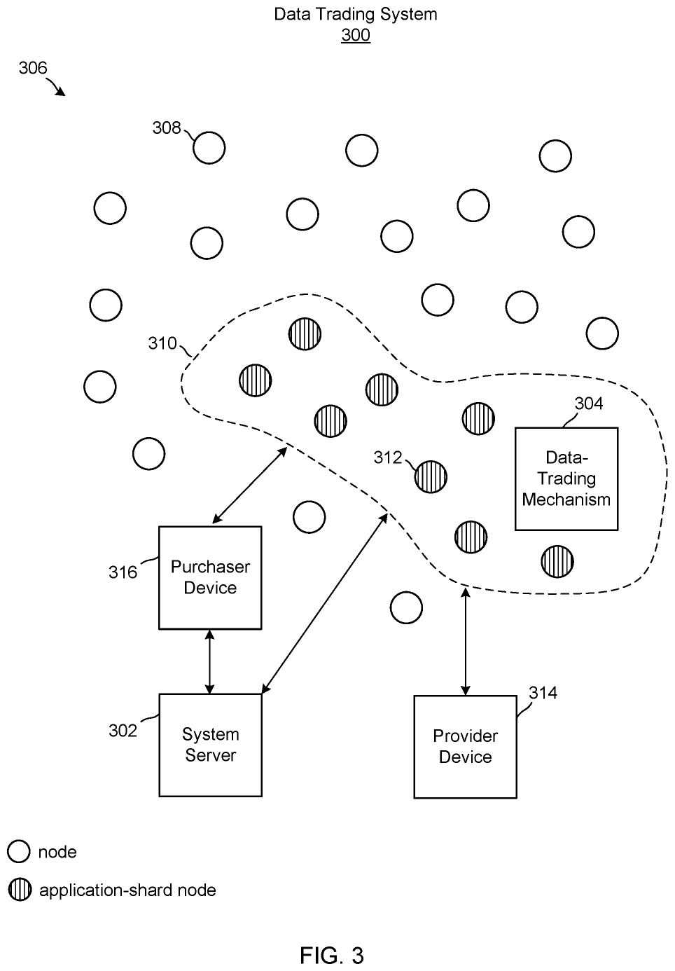

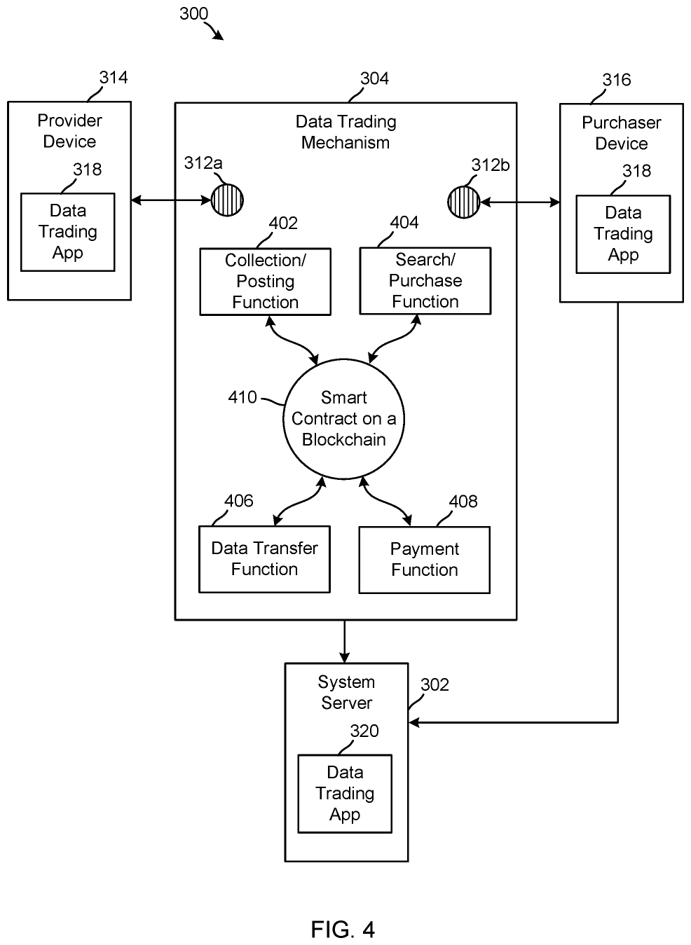

With reference to FIGS. 3 and 4, a data trading system 300 includes a system server 302 and a data trading mechanism 304. The data trading mechanism 304 may be implemented using one or more nodes of a decentralized network of nodes that are configured to execute blockchain transactions. For example a peer-to-peer network 306 having a large number of distributed nodes 308 may form a decentralized network or system. The number of nodes 308 in the decentralized network 306 may be, for example, around 10,000.

The nodes 308 within the decentralized network 306 may be grouped into one or more application shards. While a large number of nodes and shards may be present in a decentralized network, for ease of illustration, a reduced number of nodes and a single application shard 310 are shown in FIG. 3. The application shard 310 represents a logical grouping of nodes 312 within the decentralized network 306, that function together to execute or run the data trading mechanism 304.

In one configuration, the data trading mechanism 304 is embodied as a decentralized application (DAPP) that is run by the nodes 312 associated with the application shard 310. The nodes 312 in the application shard 310 may be configured and coordinated to perform certain sub-mechanisms or functions of the data trading mechanism 304 via a smart contract on a blockchain 410. As used herein, a smart contract on a blockchain 410 is a piece of code that is deployed on a shared, replicated ledger that maintains its state, controls its assets, and responds to incoming external information or assets. The model defined by the smart contract is a computer program running on a replicable, shared book that can process information, receive, store, and send value. In one embodiment, the smart contract complies with the ERC721 standard and is configured to store multiple signature information.

The certain functions executed by the smart contract on the blockchain 410 may include: 1) a collection/posting function 402 that receives data information from a data provider and posts some or all of the information to the smart contract on a blockchain 410 and sometimes to the system server 302, 2) a search/purchase function 404 that enables access to data information posted on the system server 302 and processes the purchase of data by a data purchaser, 3) a data transfer function 406 that generates a data-product token that enables the transfer of purchased data from the data provider to the data purchaser, and 4) a payment function 408 that transfers financial consideration paid by the data purchaser to the data provider after successful transfer of the purchased data to the data purchaser.

With continued reference to FIGS. 3 and 4, devices 314, 316 operating in accordance with a client-side data trading application 318 interact with the data trading mechanism 304 to engage in the posting, purchase, and transfer of data. A first device 314, referred to as a provider device, operating in accordance with a client-side data trading application 318 resident on the first device, may access a node 312a of the data trading mechanism 304 and invoke the smart contract on the blockchain 410 to perform the various functions of the data trading mechanism 304. Likewise, a second device 316, referred to as a provider device, operating in accordance with a client-side data trading application 318 resident on the second device, may access a node 312b of the data trading mechanism 304 and invoke the smart contract on the blockchain 410 to perform the various functions of the data trading mechanism 304.

With reference to FIG. 4 and from the perspective of a data provider, the client-side data trading application 318 enables the provider device 314 to receive inputs corresponding to data information. For example, the client-side data trading application 318 may cause the provider device 314 to display a graphical user interface through which a user may enter information relevant to the data. The data information may include, for example, a description of the data, a purchase price for the data, a data interface, e.g., an API URL that references the location of the data, and a duration of the availability of the data.

The client-side data trading application 318 also enables the provider device 314 to submit the data information to the node 312a for posting to a smart contract on a blockchain 410. For example, the client-side data trading application 318 may cause the provider device 314 to display a “submit information” button, which when activated causes the provider device to communicate the data information to the data trading mechanism 304 through the node 312a. To this end, the provider device 314 includes a communication interface configured to establish a communication link with the node 312a and to transmit the data information over the communication link.

From the perspective of the data trading system 300, the data trading mechanism 304 operating in accordance with the collection/posting function 402 of the smart contract on the blockchain 410 receives the data information from the provider device 314 and posts some or all of the data information in the smart contract on the blockchain 410. With regard to posting in the smart contract on blockchain 410, the data trading mechanism 304 enters or appends a data structure corresponding to the data information to a smart contract on a blockchain.

The data structure appended to the smart contract on the blockchain 410 includes the meta data of the data information, but not the data itself. The meta data may include, for example, the description of the data, the purchase price for the data, the data interface, e.g., an API URL that references the location of the data, and the duration of the availability of the data. In some cases, to be described later below, some of the data information stored in the smart contract on the blockchain 410 may be posted to a web page in the system server 302 to enable potential purchasers to browse potential information of interest. To this end, the smart contract on the blockchain 410 may be configured to invoke a node 312 of the data trading mechanism 304 to establish a communication link with the system server 302 and to transmit the data information to the system server. The information posted to the system server may be a subset of the information posted to the smart contract. For example, the information posted to the system server 302 may include the description, purchase price and duration of availability information, but not the data interface information.

Continuing with reference to FIG. 4 and from the perspective of a data purchaser, the client-side data trading application 318 enables the purchaser device 316 to receive inputs corresponding to data search criteria. For example, the purchaser device 316 may access the smart contract on the blockchain 410 through the data trading mechanism 304 and search the smart contract on a blockchain for data that is available for purchase. To this end, the purchaser device 316 may establish a communication link with a node 312b of the data trading mechanism 304 and transmit a data search request to the data trading system 300 over the communication link, through a node 312b of the data trading mechanism 304. The client-side data trading application 318 may cause the purchaser device 316 to display a graphical user interface through which a user may enter information relevant to data that the purchaser is seeking to purchase. The search information may include, for example, a description of the data and a price for the data. For example, a user interested in weather data may enter data search criteria “2018 third quarter, U.S. weather temperature hourly.” The purchaser device 316 may display a “search” button, which when activated causes the purchaser device to communicate the data search criteria to the data trading mechanism 304.

In cases where a search of the data information posted in the smart contract on a blockchain 410 results in one or more matches, the data trading mechanism 304 enables the purchaser device 316 to display the data information corresponding to the search query matches, for viewing an browsing by the purchaser. To this end, the data trading mechanism 304 may establish a communication link with the system server 302 and transmit the data information corresponding to the search query matches to the system server.

Upon locating data of interest, the purchaser device 316 operating in accordance with a client-side data trading application 318 resident on the device may purchase data through the data trading mechanism 304 using data-purchase tokens that are purchased in advance by the data purchaser. To this end, the purchaser device 316 may establish a communication link with a node 312b of the data trading mechanism 304 and transmit a purchase data request to the data trading system 300 over the communication link, through a node 312b of the data trading mechanism 304.

From the perspective of the data trading system 300, the node 312b receives the purchase request from the purchaser device 316. The purchase request may include, for example, an identifier of the data that is being purchased and compensation information, e.g., data-purchase token information, necessary to complete the purchase. Upon receipt of the purchase request, the smart contract on the blockchain 410 operating in accordance the search/purchase function 404 processes the purchase, e.g., receives the appropriate data-purchase token. The smart contract on the blockchain 410 is also configured to retain the compensation, e.g., data-purchase token, associated with the purchase for subsequent transfer to the data provider.

Continuing with FIG. 4 and from the perspective of the data trading system 300, upon completion of a data purchase, the data trading mechanism 304 operating in accordance with the data transfer function 406 implemented by the smart contract on the blockchain 410 initiates a data exchange. To this end, the smart contract on the blockchain 410 generates a data-product token and appends it as an entry in the smart contract. As part this function, the smart contract on the blockchain 410 writes a first unique identification code, e.g., the data trading system's signature, of the data trading system into the smart contract. This first unique identification code is written using the private key signature of the data trading system 300. The smart contact at this stage of the data transfer function 406 includes the data-product token and the signature of the data trading system. The data-product token includes the data information, e.g., a description of the data, a purchase price for the data, a data interface, e.g., an API URL that references the location of the data and a duration of the availability of the data, corresponding to the purchased data.

The data trading mechanism 304 then provides the signed smart contract with the data-product token to the purchaser device 316. For example, a node 312b of the data trading mechanism 304 includes a communication interface configured to establish a communication link with the purchaser device 316 and to transmit the smart contract with the data-product token over the communication link. Alternatively, the data trading mechanism 304 may provide one or more location identifiers that inform the purchaser device 316 of the location of the smart contract with the data-product token within the blockchain.

From the perspective of the purchaser device 316, upon receipt of the smart contract with data-product token from the data trading mechanism 304, the purchaser device operating in accordance with the client-side data trading application 318 resident on the purchaser device may, through a node 312b of the data trading mechanism 304, invoke the smart contract on the blockchain 410 to append a second unique identification code, e.g., purchaser's signature, to the smart contract. This second unique identification code corresponds to the private key signature of the purchaser and is received by the smart contract through the purchaser device 316. The smart contract at this stage of the data transfer function 406 includes the data-product token, the signature of the data trading system and the signature of the purchaser. The data-product token includes the data information, e.g., a description of the data, a purchase price for the data, a data interface, e.g., an API URL that references the location of the data and a duration of the availability of the data, corresponding to the purchased data.

The purchaser device 316 operating in accordance with the client-side data trading application 318 resident on the purchaser device reads the data interface, e.g., the API URL of the data provider from the data structure of the data-product token. The purchaser device 316 initiates a call to the provider device 314 using the data interface present in the data-product token, and transfers the smart contract with the data-product token directly to the provider device. To this end, each of the provider device 314 and the purchaser device 316 include a communication interface configured to establish a communication link with other devices for purposes of receiving and transmitting data, information, tokens, etc.

From the perspective of the provider device 314, upon receipt of the data call and the smart contract with the data-product token from the purchaser device 316, the provider device operating in accordance with the client-side data trading application 318 resident on the provider device, invokes, through a node 312a of the data trading mechanism 304, the smart contract on the blockchain 410 to resolve the signatures in the smart contract to confirm that the first unique identification code corresponds to the signature of the data trading system 300 and the second unique identification code corresponds to the signature of the purchaser. Upon verification of the signatures, the provider device 314 sends the purchased data to the purchaser device 316. The provider device 314 also generates a verified token and sends the verified token to the data trading system 300. The verified token is a cryptocurrency that includes data access verification information corresponding to the signature of the data trading system and the signature of the purchaser.

From the perspective of the data trading system 300, upon receipt of the verified token from the provider device 314, the data trading mechanism 304 operating in accordance with the payment function 408 implemented by the smart contract on the blockchain 410 transfers payment to the data provider. To this end, the smart contract on the blockchain 410 may be configured to use the private key signature information of the data trading system 300 included in the verified token to process a payment to the data provider corresponding to the purchase payment, e.g., data-purchase token, submitted by the data purchaser to the data trading system 300.

The disclose data trading system 300 and data trading mechanism 304 have several beneficial aspects. For example, the system and mechanism ensure that data providers and data purchasers conduct secure data transactions through third-party data exchanges. The mechanism further ensures that third-party data exchange systems do not have direct access to the data. Due to the open consensus attribute of the smart contract on the blockchain 410, all aspects of a data transaction are completely transparent to all three parties; and the three parties, i.e., data provider, data purchaser, and data exchange system, may complete a transaction without concern for the trustworthiness of the other parties. Also, the data transaction settlement can be verified at any time on the blockchain

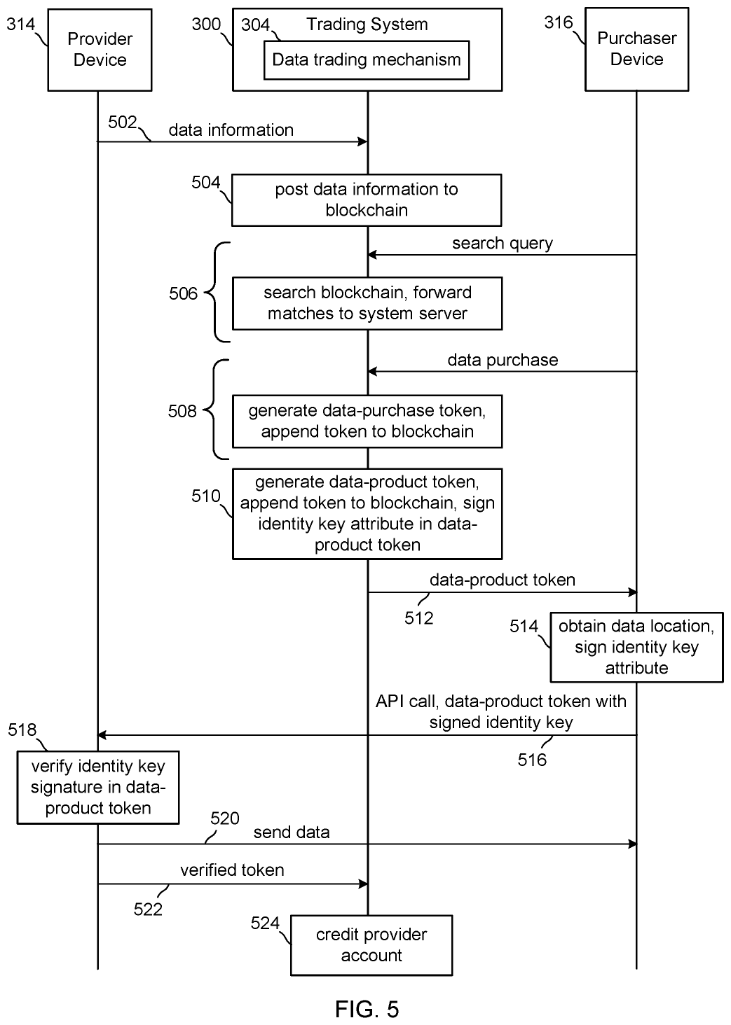

Having described the operation of the data trading system and mechanism, a detailed description of a single data trading transaction executed by the trading system of FIGS. 3 and 4 follows with reference to FIG. 5.

At operation 502, a node 312a associated with the data trading system 300 and executing the collection/posting function 402 receives data information from a provider device 314 that is registered with the data trading system. To these ends, a provider device 314 operating in accordance with a client-side data trading application 318 resident on the device may access a node 312a and invoke a smart contract on a blockchain 410 that is configured to perform certain tasks of the data trading mechanism 304 related to the collection and posting of data information.

Data information is entered into the provider device 314 through a user interface and submitted to the data trading system 300 through a node 312a. In one embodiment, the data information includes: a) identity information of the data provider, which information is confirmed by the data provider's account public key; b) a description of the data, including name, type, data source, expiration date, content category, and data sample; c) purchase price for the data; and d) the data interface, e.g., API URL, that that references the location of the data.

At operation 504, upon receiving the data information, a node 312a associated with the data trading mechanism 304 invokes a smart contract on a blockchain 410 of the data trading mechanism to execute a collection/posting function 402. In accordance with this function, the smart contract creates a record of data information based on the received information. The record of data information is posted as an entry in the smart contract on a blockchain 410.

At operation 506, the data trading system 300 enables the searching of data products that have been posted to the blockchain. To this end, a node 312b associated with the data trading system 300 receives a search query from a purchaser device 316 that is registered with the data trading system. For its part, the purchaser device 316 operating in accordance with a client-side data trading application 318 resident on the device accesses a node 312b and submits the search query. In response to the search query, the node 312b associated with the data trading system 300 executes a search component of the search/purchase function 404. This search component invokes a smart contract on a blockchain 410 that is configured to search the content of the blockchain for data products having data information that satisfies or matches the search query.

In cases where data information in the smart contract on a blockchain 410 satisfies or matches the search query, the node 312b executing a search component of the search/purchase function 404 forwards the data information and other data product information to the system server 302. The system server 302 operating in accordance with a server-side data trading application 320 makes the data information and description of the matching data product available to browse by the purchaser device 316. To this end, the system server functions as an application server that hosts the web site of the data trading system, and post the matching information to the user interface of the web site for display on the purchaser device 316. The system server 302, however, refrains from making the identity information of the data provider and the data interface available for browsing.

At operation 508, a node 312b associated with the data trading mechanism 304 invokes the smart contract on the blockchain 410 to execute a search/purchase function 404. In accordance with this function, the smart contract receives a request to purchase a data product from a purchaser device 316 that is registered with the data trading system 300. As noted above with reference to FIGS. 3 and 4, a purchaser device 316 operating in accordance with a client-side data trading application 318 resident on the device may access a node 312b that is configured to perform certain tasks of the data trading mechanism 304 related to the purchase of data. For example, a purchaser device 316 may submit a purchase request after finding a data product of interest during a search operation 506. As part of a data purchase, the purchaser device 316 buys a data-purchase token, e.g., a cryptocurrency token, by providing some form of compensation to the data trading system 300. The compensation provided for the data-purchase token may correspond to the purchase price of the data included in the data information. Prior to initiating a purchase of data, the data purchaser registers with the data trading system 300, generates an account and obtains the public and private keys of this account. Upon receipt of a data purchase request, the data trading mechanism 304 invokes the smart contract on the blockchain 410 to generate the data-purchase token and appends the data-purchase token to the smart contract on the blockchain.

At operation 510, a node associated with the data trading mechanism 304 invokes the smart contract on the blockchain 410 to execute an aspect of a data transfer function 406. In accordance with this aspect, the smart contract on a blockchain 410 generates a data-product token for the purchased data and appends the data-product token to the smart contract on the blockchain. The data-product token includes one or more pieces of the data information of the purchased data. For example, the data-product token may include the data description, the data price, and the data interface, e.g., an API URL, that references the location of the data. As part of a data purchase and data-product token generation, the data trading mechanism 304 signs an identity key attribute in the data-product token with a unique identification code using the private key of the data trading system 300, and saves the key in the attributes of the smart contract. The signature process is based on the Elliptic Curve Digital Signature Algorithm (ECDSA) algorithm.

It is noted that the data-product token generated by the smart contract has no pre-defined amount, and may be generated on request for different kinds of data. In one embodiment, the generated data-product token is a type of ERC721 token that can hold rich data information. ERC721 is a free, open standard that describes how to build non-fungible or unique tokens on the Ethereum blockchain. While most tokens are fungible (every token is the same as every other token), ERC721 tokens are all unique.

At operation 512, a node associated with the data trading mechanism 304 invokes another aspect of a data transfer function 406. In accordance with this aspect of the data transfer function, the data trading mechanism 304 sends the data-product token associated with the data purchase to the purchaser device 316 through a node 312 associated with the data trading system 304.

At operation 514, the purchaser device 316, operating in accordance with a client-side data trading application 318 and a smart contract on a blockchain 410, determines the legality of the data-product token and then signs the identity key attribute. To determine the legality of the data-product token, the client-side data trading application 318 adopts the Elliptic Curve Digital Signature Algorithm (ECDSA) algorithm, and performs an elliptic curve (EC) recover operation on the data-product token to obtain the public address information of the data trading system 300, thereby confirming that the data-product token was generated by and signed by the data trading system. To sign the data-product token, the client-side data trading application 318 resident on a purchaser device 316 receives input from a purchaser corresponding to the private key of the purchaser. The private key functions as the purchaser's signature for the data-product token. At operation 514, the purchaser device 316 also obtains the data information from the data-product token in the smart contract, including the data interface, e.g., an API URL that references the location of the purchased data.

At operation 516, the purchaser device 316, operating in accordance with a client-side data trading application 318, sends the provider device 314 the data-product token with the signed identity key when calling the data location. This operation is performed directly between the purchaser device 316 and the provider device 314 and does not invoke the smart contract on the blockchain 410 of the data trading mechanism 304.

At operation 518, the provider device 314 receives the API call and the data-product token with the signed identity key from the purchaser device 316. The provider device 314, operating in accordance with a client-side data trading application 318, verifies that the data-product token includes the signature of the data purchaser and the signature of data trading system 300. To this end, an algorithm resident in the provider device 316 or resident in the data trading mechanism 304 but accessible by the provider device uses v, r, s in Elliptic Curve Digital Signature Algorithm (ECDSA) to verify if the signed information was from the public key of trading system 300

At operation 520, the provider device 314, operating in accordance with a client-side data trading application 318, sends the purchased data to the purchaser device 316. This operation is performed directly between the purchaser device 316 and the provider device 314 and does not invoke the smart contract on the blockchain 410 of the data trading mechanism 304.

At operation 522, a node associated with the data trading mechanism 304 receives a verified token from the provider device 314. This operation is performed directly between the provider device 314 and the node 312 and does not invoke the smart contract on the blockchain 410 of the data trading mechanism 304. The verified token is generated by the provider device 314 and is a cryptocurrency that includes data access verification information corresponding to the signature of the data trading system and the signature of the purchaser. The verified token confirms that the purchased data was sent by the provider to the purchaser.

At operation 524, a node associated with the data trading mechanism 304 invokes the smart contract on the blockchain 410 to execute a payment function 408. In accordance with this function, the smart contract credits an account associated with the data provider an amount based on the price of the data-purchase token paid for by the provider.

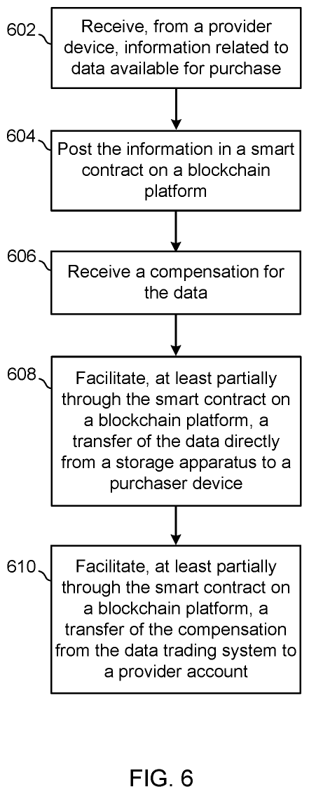

FIG. 6 is a flowchart of an example method of trading information based on blockchain. The method may be performed, for example, by the data trading mechanism of FIGS. 3 and 4.

At block 602, a node of the data trading mechanism 304 receives one or more inputs corresponding to the data information from a provider device. The data information may include a data interface that references a location of the data within the storage apparatus, a description of the data, and a price for the data. The data information posted in the data trading system does not include identity information of a provider of the data. This prevents the data purchaser from being able to directly contact a data provider and bypass the data trading system.

At block 604, a node of the data trading mechanism 304 posts data information related to data that is located in a storage apparatus independent of the data trading system and available for purchase in a data trading system. The storage apparatus may be, for example, associated with the provider device. The data information is posted by appending the data information to the smart contract on the blockchain.

The data information posted in the smart contract on the blockchain may be searched against a search query received from the purchaser device. If relevant data information is located during a search, at least a portion of the located data information may be transmitted from the blockchain to a system server and output from the system server for display at the purchaser device.

At block 606, a node of the data trading mechanism 304 receives a compensation for the data from a purchaser device. The compensation may be a data-purchase token in the form of a cryptocurrency.

At block 608, a node of the data trading mechanism 304 facilitates a transfer of the data directly from the storage apparatus to the purchaser device. To this end, the node generates via the smart contract on a blockchain, a data-product token that includes at least a portion of the information corresponding to the purchased data. The node also appends the data-product token to the smart contract together with a signature of the data trading system, and transmits smart contract with the data-product token to the purchaser device.

At block 610, a node of the data trading mechanism 304 facilitates, at least partially through the smart contract on a blockchain, a transfer of the compensation from the data trading system to a provider account. To this end, the node receives, from a provider device, a verified version of the smart contract with the data-product token indicating that the transfer of the purchased data associated with the data-product token has been completed. The node then transfers an amount corresponding to the compensation for the data to the account associated with the purchased data.

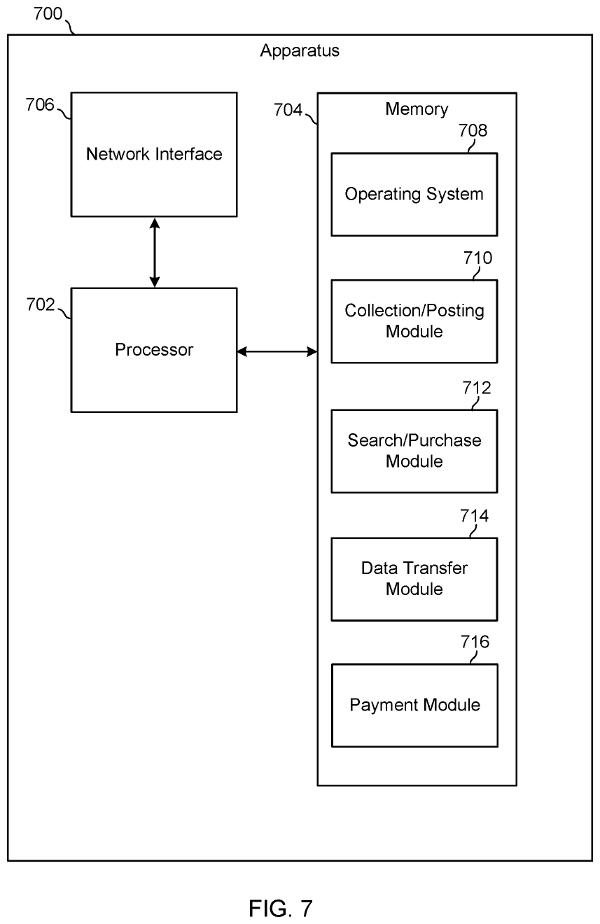

FIG. 7 is a schematic block diagram of an apparatus 700. The apparatus 700 may correspond to one of the one or more nodes 312 of a decentralized network of nodes that are grouped into an application shard 310 and that function together to run a decentralized application that implements the data trading mechanism 304, as described above with reference to FIGS. 3, 4 and 5.

The apparatus 700 may include one or more processors 702 configured to access and execute computer-executable instructions stored in at least one memory 704. The processor 702 may be implemented as appropriate in hardware, software, firmware, or combinations thereof. Software or firmware implementations of the processor 702 may include computer-executable or machine-executable instructions written in any suitable programming language to perform the various functions described herein. The processor 702 may include, without limitation, a central processing unit (CPU), a digital signal processor (DSP), a reduced instruction set computer (RISC) processor, a complex instruction set computer (CISC) processor, a microprocessor, a microcontroller, a field programmable gate array (FPGA), a System-on-a-Chip (SOC), or any combination thereof. The apparatus 700 may also include a chipset (not shown) for controlling communications between the processor 702 and one or more of the other components of the apparatus 700. The processor 702 may also include one or more application-specific integrated circuits (ASICs) or application-specific standard products (ASSPs) for handling specific data processing functions or tasks.

The memory 704 may include, but is not limited to, random access memory (RAM), flash RAM, magnetic media storage, optical media storage, and so forth. The memory 704 may include volatile memory configured to store information when supplied with power and/or non-volatile memory configured to store information even when not supplied with power. The memory 704 may store various program modules, application programs, and so forth that may include computer-executable instructions that upon execution by the processor 702 may cause various operations to be performed. The memory 704 may further store a variety of data manipulated and/or generated during execution of computer-executable instructions by the processor 702.

The apparatus 700 may further include one or more network interfaces 706 that may facilitate communication between the apparatus 700 and one or more other nodes using any suitable communications standard. For example, a LAN interface may implement protocols and/or algorithms that comply with various communication standards of the Institute of Electrical and Electronics Engineers (IEEE), such as IEEE 802.11, while a cellular network interface implement protocols and/or algorithms that comply with various communication standards of the Third Generation Partnership Project (3GPP) and 3GPP2, such as 3G and 4G (Long Term Evolution), and of the Next Generation Mobile Networks (NGMN) Alliance, such as 5G.

The memory 704 may store various program modules, application programs, and so forth that may include computer-executable instructions that upon execution by the processor 702 may cause various operations to be performed. For example, the memory 704 may include an operating system module (O/S) 708 that may be configured to manage hardware resources such as the network interface 706 and provide various services to applications executing on the apparatus 700.

The memory 704 stores additional program modules such as collection/posting module 710, the search/purchase module 712, the data transfer module 714, and the payment module 716, each of which includes functions in the form of logic and rules that respectively support and enable the collection/posting, the search/purchase, the data transfer, and the payment function described above with reference to FIGS. 3, 4 and 5. Although illustrated as separate modules in FIG. 7, one or more of the modules may be a part of or a submodule of another module.

The apparatus 700 and modules 710, 712, 714, 716 disclosed herein may be implemented in hardware or software that is executed on a hardware platform. The hardware or hardware platform may be a general purpose processor, a digital signal processor (DSP), an application specific integrated circuit (ASIC), a field programmable gate array (FPGA) or other programmable logic component, discrete gate or transistor logic, discrete hardware components, or any combination thereof, or any other suitable component designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP, or any other such configuration.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, a smart card, a flash memory device (e.g., card, stick, key drive), random access memory (RAM), read only memory (ROM), programmable ROM (PROM), erasable PROM (EPROM), electrically erasable PROM (EEPROM), a general register, or any other suitable non-transitory medium for storing software.

The various aspects of this disclosure are provided to enable one of ordinary skill in the art to practice the present invention. Various modifications to exemplary embodiments presented throughout this disclosure will be readily apparent to those skilled in the art. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method of trading data, the method comprising:
posting, in a data trading system, data information related to data that is located in a storage apparatus independent of the data trading system and available for purchase;
receiving, from a purchaser device, a compensation for the data;
facilitating, at least partially through a smart contract on a blockchain, a transfer of the data directly from the storage apparatus to the purchaser device; and
facilitating, at least partially through the smart contract on a blockchain, a transfer of the compensation from the data trading system to a provider account.

2. The method of claim 1, wherein posting the data information comprises appending the data information to the smart contract on the blockchain.

3. The method of claim 2, wherein posting the data information further comprises searching the data information against a search query received from the purchaser device.

4. The method of claim 3, wherein posting the data information further comprises:
transmitting at least a portion of the data information from the blockchain to a system server when the search query results in a match; and
outputting from the system server the data information for display at the purchaser device.

5. The method of claim 1, further comprising receiving, from a provider device, one or more inputs corresponding to the information.

6. The method of claim 5, wherein the information comprises a data interface, that references a location of the data within the storage apparatus, a description of the data, and a price for the data.

7. The method of claim 6, wherein the information posted in the data trading system does not include identity information of a provider of the data.

8. The method of claim 1, wherein facilitating a transfer of data comprises:
generating through the smart contract on a blockchain, a data-product token comprising at least a portion of the data information corresponding to the data;
appending the data-product token to the smart contract together with a signature of the data trading system; and
transmitting the data-product token to the purchaser device.

9. The method of claim 8, wherein facilitating a transfer of data further comprises:
receiving, from a provider device, a verified token indicating that the transfer of the data associated with the data-product token has been completed.

10. The method of claim 9, wherein facilitating a transfer of the compensation comprises:
transferring through the smart contract on a blockchain, to the account associated with the data, an amount corresponding to the compensation for the data.

11. An apparatus for trading data, the apparatus comprising:
a network interface;
a memory; and
a processor coupled to the network interface and the memory and configured to:
post, in a data trading system, data information related to data that is located in a storage apparatus independent of the data trading system and available for purchase;
receive, from a purchaser device, a compensation for the data;
facilitate, at least partially through a smart contract on a blockchain, a transfer of the data directly from the storage apparatus to the purchaser device; and
facilitate, at least partially through the smart contract on a blockchain, a transfer of the compensation from the data trading system to a provider account.

12. The apparatus of claim 11, wherein the processor posts the data information by being further configured to append the data information to the smart contract on the blockchain.

13. The apparatus of claim 12, wherein the processor posts the data information by being further configured to search the data information against a search query received from the purchaser device.

14. The apparatus of claim 13, wherein the processor posts the data information by being further configured to:
transmit at least a portion of the data information from the blockchain to a system server when the search query results in a match; and
output from the system server the data information for display at the purchaser device.

15. The apparatus of claim 11, wherein the processor is further configured to receive, from a provider device, one or more inputs corresponding to the information.

16. The apparatus of claim 15, wherein the information comprises a data interface, that references a location of the data within the storage apparatus, a description of the data, and a price for the data.

17. The apparatus of claim 11, wherein the processor facilitate a transfer of data by being further configured to:
generate through the smart contract on a blockchain, a data-product token comprising at least a portion of the data information corresponding to the data;
append the data-product token to the smart contract together with a signature of the data trading system; and
transmit the data-product token to the purchaser device.

18. The apparatus of claim 17, wherein the processor facilitate a transfer of data by being further configured to:
receive, from a provider device, a verified token indicating that the transfer of the data associated with the data-product token has been completed.

19. The apparatus of claim 18, wherein the processor facilitate a transfer of the compensation by being further configured to transfer through the smart contract on a blockchain, to the account associated with the data, an amount corresponding to the compensation for the data.

20. A mechanism for trading data, the mechanism comprising:
a collection/posting module configured to post, in a data trading system, data information related to data that is located in a storage apparatus independent of the data trading system and available for purchase;
a search/purchase module configured to receive, from a purchaser device, a compensation for the data;
a data transfer module configured to facilitate, at least partially through a smart contract on a blockchain, a transfer of the data directly from the storage apparatus to the purchaser device; and
a payment module configured to facilitate, at least partially through the smart contract on a blockchain, a transfer of the compensation from the data trading system to a provider account.
